(19) United States
(12) Patent Application Publication
(10) Pub. No.: US 2002/0027509 A1
(43) Pub. Date: Mar. 7, 2002

(54) Object detection system

(76) Inventors: Kouichi Tanokura, Tokyo (JP); Nobuki Mieda, Tokyo (JP); Hirohide Ito, Tokyo (JP); Hiroaki Tanaka, Tokyo (JP)

Correspondence Address: McGinn & Gibb, PLLC, 8321 Old Courthouse Road; Suite 200, Vienna, VA, 22182-3817, US

(21) Appl. No.: 09/820,173

(22) Filed: Mar. 29, 2001

(30) Foreign Application Priority Data
Sep. 1, 2000 (JP) 2000-265814

(51) Int. Cl. H04Q 5/22; G08B 5/22

(52) U.S. Cl. 340/825.49; 340/10.31

(57) ABSTRACT

An object detection system is capable of easily detecting the objects which lie scattered widely by sending a radio signal of an MF band for the transmission of a control signal between the objects to be detected and a detecting device. An object detecting device arranged on the ground in the form of a ground device (1) and objects to be detected in the form of underground devices (2) buried in the underground are each constructed to perform the transmission and reception of radio signals therebetween. When the ground device (1) transmits instruction data (S1) for object detection, the underground devices (2) receive the instruction data (S1) and return response data (S2) to the ground device (1) if the electric field level of the instruction data (S1) received is equal to or greater than a prescribed regulated value. A signal carrier carrying the instruction data or the response data between the ground device (1) and the underground devices (2) adopts a radio signal of an MF band. In addition, only one frequency in the MF band is allocated to the signal carrier, but in order for one ground device (1) to detect a plurality of underground devices (2), the ground device (1) adjusts the electric field level (i.e., the magnitude of the radio signal to be transmitted therefrom) and checks the content of data received, thus discriminating the plurality of underground devices from one another.

### BACKGROUND OF THE INVENTION

1. Field of the Invention

The present invention relates to an object detection system for detecting the places of existence of objects, and in particular, to such an object detection system capable of detecting objects buried in the ground or the like by using a radio signal of a medium frequency (MF) band.

2. Description of the Related Art

In the past, for object detecting apparatuses or object finders for detecting or finding objects buried or concealed in the ground or the like. there have been known metal detectors, pressure sensitive detectors and so on. A metal detector is caused to move toward and away from a magnetic material such as a buried object so that the amount of change in the current flowing in a search coil is sensed to find the existence of the buried object. In contrast, a pressure sensitive detector is constructed such that when a buried object is stepped on by a person, a microswitch, a pressure sensor or the like incorporated in the buried object is operated to generate a sound, light, smoke, etc., to notify the person of the existence of such an object.

However, unless the search coil does considerably approach a buried object or the like, the metal detector as referred to above cannot detect the amount of change in the current flowing in the search coil. That is, the objects to be detected, if present in a limited and narrow area, can be easily detected, but it is difficult to find them when lying scattered in a wide area. On the other hand, the pressure sensitive detector can not detect an object buried in the ground unless the buried object is stepped on by somebody, so it is also difficult to detect a plurality of objects scattering in a wide area. In other words, since the objects being buried or hidden in the ground are usually scattering arbitrarily in a vast area, the pressure sensitive detector will sometimes have to spend a considerable time in detecting the places of existence of them.

### SUMMARY OF THE INVENTION

In view of the above, the object of the present invention is to provide an object detection system of the character described which is capable of detecting objects scattering in a wide area without difficulty through the transmission of a signal between the objects to be detected and a detection device using radio waves of a medium frequency band for example.

Bearing the above object in mind, according to the present invention, there is provided an object detection system including a detection device for detecting objects present in unspecified places based on radio signals. The object detection system comprises a first transmitting and receiving section provided on the detection device for transmitting and receiving a radio signal, and a second transmitting and receiving section provided on each of the objects to be detected for transmitting and receiving a radio signal. When the first transmitting and receiving section of the detection device transmits a radio signal for detecting the object, the second transmitting and receiving section of each of the objects receives the radio signal transmitted from the first transmitting and receiving section and sends a radio signal representative of response information to the detection device when an electric field level of the radio signal received by the second transmitting and receiving section is equal to or greater than a predetermined value. The detection device detects the presence of the objects by judging from an electric field level of each of the radio signals received and the content of the response information received.

Specifically, the object detection system of the present invention is constructed such that the detecting device and the objects to be detected are each provided with the transmitting and receiving section for performing the transmission and reception of radio signals therebetween. The object to be detected each return to the detecting device a radio signal containing response information only when the electric field level of the radio signal received is equal to or greater than a prescribed regulated value. The detecting device detects the existence of an object to be detected judging from the response information contained in the radio signal when the electric field level of the radio signal received is equal to or greater than another prescribed regulated value. Thus, by virtue of regulated data communications between the detecting device and the objects to be detected, the object detection system of the present invention, unlike the metal detector or the like, is able to detect the objects lying over a considerably wide area. Moreover, the objects to be detected can be found and specified individually in a considerably short time.

In a preferred form of the present invention, the detection device further comprises a directivity adjusting section for adjusting the strength and directivity of a radio signal to be transmitted therefrom, and the detection device transmits a radio signal, of which the strength and directivity are adjusted by the directivity adjusting section, to the objects thereby to narrow the places of existence of the objects.

According to the object detection system of this preferred form of the present invention, through the adjustment or switching of the directivity adjusting section, the objects to be detected lying in a wide area can first be serched by means of a strong radio signal radiated from the detection device, and then the output power of the detection device for transmitting the radio signal is decreased gradually or stepwise to narrow the area in which there exist the objects to be detected. In this manner, the area searching for the objects to be detected can be narrowed while continuously or stepwise changing the radio signal to be transmitted, thus making it possible to construct an object detection system which is extremely convenient to use. In addition, since the directivity adjustment section can arbitrarily adjust the direction of the directivity, the radiation area of the radio signal radiated from the detection device can be moved at any time in a direction in which there exists an object or objects to be detected.

In another preferred form of the present invention, the detection device further comprises an indication section for indicating the detection of the objects, and when detection device judges the presence of each object based on the magnitude of the electric field level of each radio signal received, the indication section changes a state of indication according to the number of objects which have been detected by the detection device.

Specifically, according to the object detection system of this preferred form of the present invention, upon searching for the objects to be detected which lie in a wide area, when a plurality of objects have been found, an indication to that effect can be made, and when the search area is being narrowed to find only one object, another indication can be made. In this manner, changing the indication such as the sound of a buzzer depending upon the number of objects which have been detected, it is possible to achieve an object detection system which is considerably easy for detection operation. For instance, in the case of searching for a plurality of buried objects, by changing the magnitude of the radio wave transmission output power of the detection device to adjust the strength of radio waves radiated therefrom, the places of the buried objects can be narrowed, thereby making it possible to detect the individual buried objects respectively with ease.

In a further preferred form of the present invention, the objects are each provided with an ID number for identification thereof, and the detection device further comprises an ID indicating section for identifying the objects respectively, and the ID indicating section indicates the ID numbers of the objects detected by the detection device, thereby individually identifying the plurality of objects detected by the detection device.

With this arrangement, even if there exist a lot of objects to be detected, the objects which have been detected can be narrowed based on the ID numbers of the detected objects. As a result, it is possible to easily detect the object that is intended to be found.

In a still further preferred form of the present invention, radio signals communicated between the detection device and the objects have frequencies of a MF band provided by the Wireless Radio Act Enforcement Rule.

Thus, according to the object detection system of this preferred form of the present invention, the radio signal sent and received between the detecting device and the objects to be detected is a weak carrier of a low power output for which no application for government permission provided by the Wireless Radio Act is needed. As a consequence, there is no fear of giving rise to radio interference with other communications devices and the like.

The above and other objects, features and advantages of the present invention will become more readily apparent to those skilled in the art from the following detailed description of a preferred embodiment of the invention taken in conjunction with the accompanying drawings.

### DESCRIPTION OF THE DRAWINGS

FIG. 1 is a schematic view showing a basic configuration of an object detection system of the present invention.

FIG. 2 is a detailed block diagram of the object detection system according to the present invention.

FIG. 3 is a schematic view showing a radiation region of radio waves radiated from an antenna of a ground device.

FIG. 4 is a schematic view showing a state in which a plurality of underground devices are detected.

FIG. 5 is a table or chart showing a detection operation of the object detection system of the present invention in the case where the numbers of the underground devices which are to be detected by a plurality of ground devices, respectively, are different from each other.

### DESCRIPTION OF THE PREFERRED EMBODIMENT

Now, a preferred embodiment of the present invention will be described in detail while referring to the accompanying drawings. In the following description, a detection system for detecting objects buried in the ground will be explained in detail.

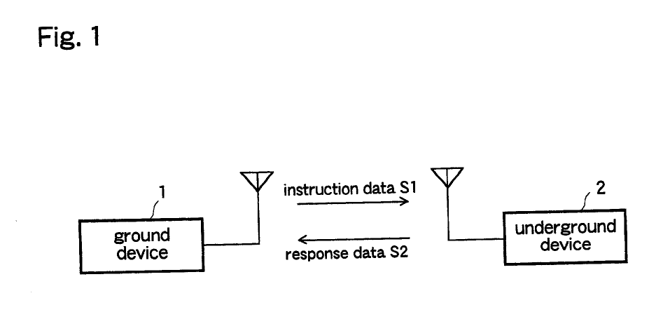

FIG. 1 schematically illustrates an overall configuration of an object detection system according to the present invention. In this figure, the object detection system of the present invention includes a ground object detecting device 1 arranged on the ground (hereinafter simply referred to as a ground device) and an object 2 to be detected (hereinafter simply referred to as an underground device) which is laid or buried in the earth or ground, with signal transmission and reception being carried out between the ground device and the underground device. That is, the object detection system is constructed such that when the ground device sends instruction data S1 for detecting an object, the underground device receives the instruction data S1 and returns response data S2 representative of its response information.

In addition, with this object detection system, in order to decrease a transmission loss in the earth or underground, a medium frequency (MF) band provided by the Wireless Radio Act Enforcement Rule or some other government Act or Regulation is adopted for a signal carrier (that is, for the instruction data S1 and the response data S2) transmitted between the ground device 1 and the underground device 2. Here, note that this signal carrier is a weak one having a low power output for which there is no need for making an application for permission to the authority as provided by the Wireless Radio Act. Moreover, in this object detection system, though the frequency of the MF band allocated to the signal carrier is only one wave, it is possible to detect a plurality of objects in the form of underground devices 2 laid in the underground with the use of one set of ground device 1 in the form of an object detecting device with an operating section. Note that in FIG. 1, only one underground device 2 is illustrated with respect to one ground device 1.

In addition, the ground device 1 checks and adjusts the level of an electric field and the content of data so that the object detection system can properly carry out the object detection processing for a plurality of underground devices. That is, in order for the ground device I to specify or identify the respective underground devices upon reception of signals from a plurality of underground devices at the same time, the ground device 1 is constructed such that it can perform the signal discrimination processing upon reception of the signals from the plurality of underground devices.

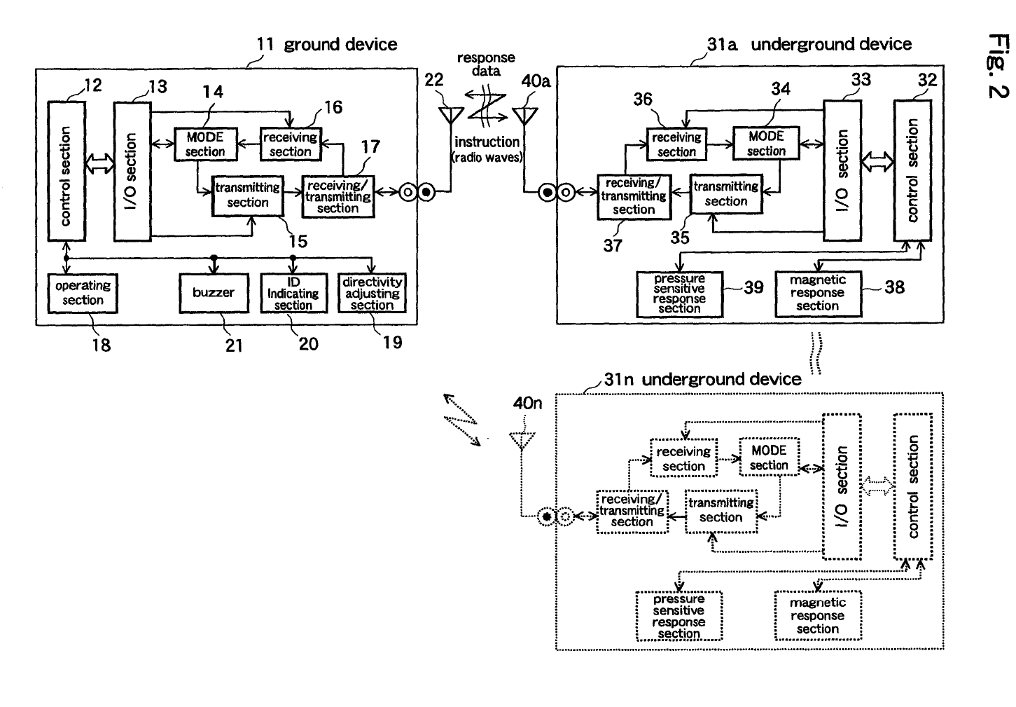

FIG. 2 is a detailed block diagram of the object detection system of the present invention. That is, FIG. 2 illustrates in detail the internal structure of a specific example, designated at reference numeral 11, of the ground device 1 and the internal structure of a specific example, designated at reference numeral 31a, of the underground device 2. In FIG. 2, the specific example 11 of the ground device 1 (hereinafter simply referred to as “ground device 11”) is constructed in such a manner that it is capable of communicating with a plurality of underground devices 31a, 31b, . . . , 31n.

The ground device 11 includes a control section 12 for controlling the entire object detection system, an input/output (I/O) section 13 acting as an I/O interface for signals input to and output from the control section 12, a MODE section 14 for switching between a transmitting system and a receiving system, a transmitting section 15 for controlling the transmission of instruction data S1 to the respective underground devices 31a, 31b, . . . , 31n, a receiving section 16 for controlling the reception of response dada S2 from the respective underground devices 31a, 31b, . . . , 31n, a transmitting and receiving section 17 for transmitting the instruction data S1 and receiving the response data S2, an operating section 18 through which a various kinds of operations are carried out for data transmission and reception, a directivity adjusting section 19 for adjusting the directivity of radio waves (i.e., the direction of transmission or reception of radio waves) and the range of radio waves in which radio waves can be effectively transmitted or received), an ID indicating section 20 for indicating or displaying which one of the plurality of underground devices 31a, 31b, . . . , 31n ID information is received from, a buzzer 21 adapted to produce, upon reception of response data S2 from one or some of the underground devices 31a, 31b, . . . , 31n, different sounds respectively according to the contents of the data received, and an antenna 22. Here, note that the ground device 11 described with reference to this embodiment is a portable device, but does not necessarily be limited to this and may be a fixed or stationary device, a device mounted on a vehicle, etc.

Also, the underground device 31 a includes a control section 32 for controlling the entire object detection system, an input/output (I/O) section 33 acting as a signal interface for signals input to and output from the control section 32, a MODE section 34 for switching between a transmission system and a receiving system, a transmission section 35 for controlling the transmission of response data S2 to the ground device 11, a receiving section 36 for controlling the reception of instruction data S1 from the ground device 11, a transmitting and receiving section 37 for performing data transmission and reception, i.e., transmitting the response data S2 and receiving the instruction data S2, a magnetic response section 38 for sensing a magnetic element such as a vehicle by causing a coil current flowing in a coil to vary when the magnetic element such as the vehicle is coming near the underground device 31a, a pressure sensitive response section 39 such as a pressure sensor for sensing the load of the magnetic element such as the vehicle which is passing over the underground device 31a, to thereby detect the passage of the magnetic element such as the vehicle, and an antenna 40.

Here, it is to be noted that there has been omitted a detailed description of the magnetic response section 38 and the pressure sensitive response section 39, both of which do not directly relate to the present invention, but the magnetic response section 38 and the pressure sensitive response section 39 can be used as a moving object detection system of the underground device 31a for detecting a moving object such as a vehicle. In addition, the structure of each of the other underground devices 31b, . . . , 31n is quite the same as that of the underground device 31a, and hence a detailed description thereof is also omitted.

Next, the operation of the object detection system as illustrated in FIG. 2, i.e., how to detect objects such as the underground devices 31a, 31b, . . . , 31n, will be explained below. First of all, let us consider that an operator or a detecting person is detecting unspecified underground devices 31a, 31b, . . . 31n while carrying and moving the ground device 11. At this time, the MODE section 14 is switched over to a transmission mode through manipulation of the operating section 18 of the ground device 11. As a result, instruction data S1 is transmitted from the transmitting section 15 of the ground device 11 via the transmitting and receiving section 17 and the antenna 22 to unspecified underground devices 31a, 31b, . . . , 31n. Then, the unspecified underground devices 31a, 31b, . . . , 31n receive the instruction data S1 through each antenna 40a, 40b, . . . , 40n, respectively, and each determine, based on the magnitude of the radio waves received or the level of the reception magnetic field (RSSI), whether or not the magnitude of the radio waves received is equal to or above a prescribed regulated value.

When the underground device 31 a has recognized a reception electric field level (RSSI) equal to or greater than the prescribed regulated value, the underground device 31a is switched over to the reception mode by means of the MODE section 34, so hat it judges the content of the instruction data S1 sent from the receiving section 36. If there is no error found in the content of the instruction data S1, the MODE section 34 is switched over to the transmission mode, so that the transmitting section 35 sends out response data S2 from the antenna 40a via the transmitting and receiving section 37 to the ground device 11. On the other hand, when the reception electric field level (RSSI) of the underground device 31a is below the regulated value, the underground device 31a does not transmit response data S2.

Subsequently, the response data S2 is received by the antenna 22 of the ground device 11 and input therefrom to the transmitting and receiving section 17. Additionally, the MODE section 14 is switched to the reception mode, so that the response data S2 is input to the receiving section 16. Then, the receiving section 16 judges, based on the reception electric field level (RSSI), whether or not the level of radio waves of the response data S2 received is equal to or greater than the regulated value. Here, when the magnitude of the radio waves received is greater than the regulated value, the ground device 11 judges the content of the response data S2 transmitted, and makes an indication in such a manner that the operator or detecting person can recognize the content of the response data S2 through the visual sense or the auditory sense, thereby notifying the operator of the presence of the underground device 31a buried in the nearby ground. For instance, the operator is informed by the rumbling of the buzzer 21 that there exists the underground device 31a near the location at which the operator stands. On the contrary, no response is made by the ground device 11 when the magnitude of the radio waves received is below the regulated value. Moreover, identification (ID) numbers are allocated in advance to the underground devices 31a, 31b, . . . , 31n, respectively, and hence the ID indicating section 20 indicates or displays the ID number corresponding to the detected underground device 31a. As a result, the operator can know which underground device has been detected.

Now, reference will be made to the operation of the ground device 11 for detecting underground devices by adjusting the directivity of the antenna 22 and the range where the radio waves transmitted from the antenna 22 can reach while narrowing the underground devices. The operator adjusts or manipulates an unillustrated volume or changeover switch of the directivity adjusting section 19 so that the ground device 11 first outputs strong radio waves for searching over a wide area and then gradually reduces the magnitude of the radio waves so as to narrow the detection range.

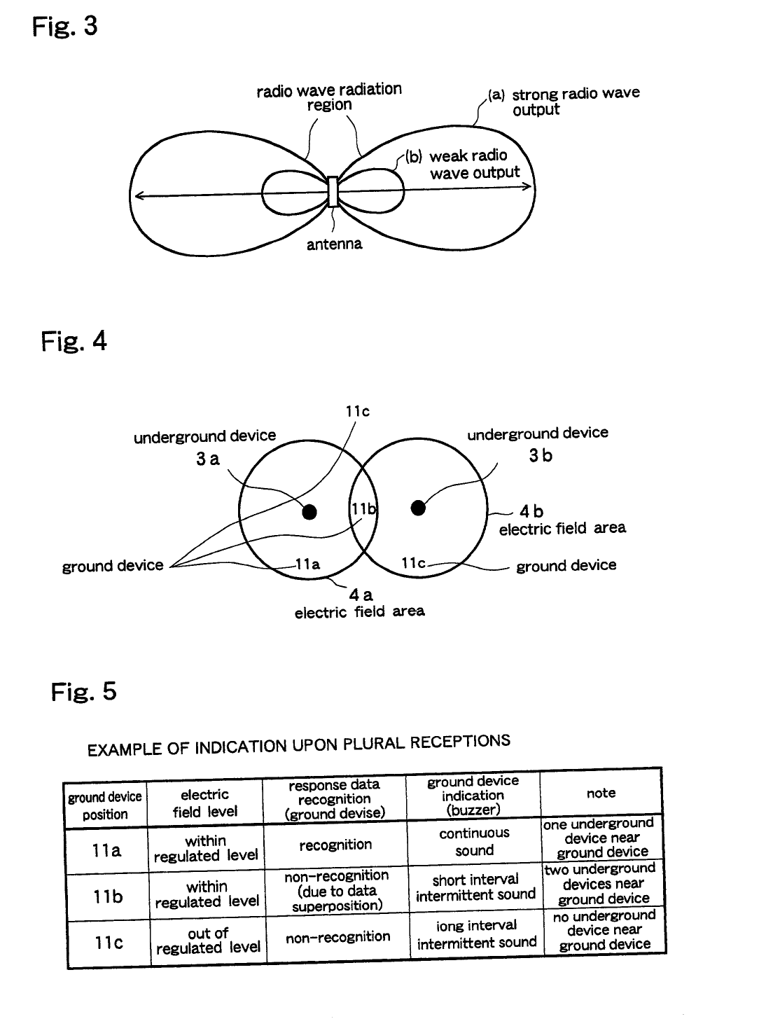

FIG. 3 schematically shows a radiation region of the radio waves radiated from the antenna 22 of the ground device 11. As illustrated in this figure, underground devices are first searched by the ground device 11 with a strong output of radio waves designated at (a). At this time, since the directivity of the radio waves may not necessarily be addressed to the direction of underground devices, the direction of the antenna 22 is rotated by 360 degrees so that the radio waves can reach the whole search area to specify the direction of the underground devices. If an underground device has been detected in a certain direction, then the ground device 11 is moved in that direction to approach the specific underground device, with the radio wave output of the ground device 11 being switched into a weak radio wave output, as illustrated at (b) in FIG. 3, through manipulation of the directivity adjusting section 19. As a consequence, it is possible to detect the underground device by narrowing the search area.

More specifically, by switching the radio wave output of the ground device 11 between the strong mode and the weak mode as illustrated in FIG. 3, the detection of underground devices over a wide area can be carried out by the use of the “strong” radio wave output. Subsequently, once a plurality of underground devices have been found within the radio wave radiation range, the output of the ground device 11 is switched over to the “weak” radio wave output, whereby the search area can be narrowed to effectively detect a single underground device. In this manner, the search area can be narrowed into a range of about 1 m square for instance.

Next, reference will be made to the operation of the object detection system in the case of a plurality of underground devices being detected at the same time.

FIG. 4 schematically illustrates the state in which a plurality of groups of underground devices respectively including a different number of underground devices, and FIG. 5 is a comparison diagram showing the detecting operations of the object detection device in cases where there are a plurality of underground devices to be detected differing in number in the respective search areas. That is, as illustrated in FIG. 4, there exist one or first underground device 3a and another or second underground device 3b in the mutually adjacent locations, with a first electric field area 4a of the first underground device 3a overlapping in part with a second electric field area 4b of the second underground device 3b. On the other hand, there are three kinds of ground devices including a first kind of two ground devices 11a which exist in the first electric field area 4a of the first underground device 3a and in the second electric field area 4b of the second underground device 3b, respectively, a second kind of ground device 11b which exists in a third common electric field area in which the first electric field area 4a and the second electric field area 4b overlap with each other, and a third kind of ground device 11c which exists in a fourth area coming off from the first and second electric field areas 4a, 4b.

Referring to the diagram of FIG. 5, in case where there exists one underground device in the vicinity of a ground device, that is, when the first ground device 11a lies in any of the first electric field area 4a and the second electric field area 4b, the level of the electric field is within a prescribed regulated level so that the first ground device 11a can recognize the response data received from the first underground device 3a or the second underground device 3b. At this time, the first ground device 11a generates, as an indication, a buzzer sound in the form of a “continuous sound”. Also, at this time, as described previously, the ID number of the detected underground device 3a or 3b is indicated or displayed by the ID indicating section of the ground device 11a, and hence it is possible to identify the first underground device 11a or the second underground device 11b which has been detected by the ground device 11a, through the ID number indicated.

Next, in the case where there exist two underground devices 3a and 3b near a ground device, that is, when the second ground device 11b exists in the common area in which the first and second electric field areas 4a, 4b overlap with each other, the electric field level is within the prescribed regulated level but the second ground device 11b can not recognize those response data which have been received from the first underground device 3a and the second underground device 3b due to the superposition of these data. At this time, the buzzer of the second ground device 11b generates, as an indication, a buzzer sound in the form of an “intermittent sound at long intervals”.

Specifically, when the second ground device 11b receives response data from a plurality of (e.g., two in the illustrated example) underground devices 3a, 3b, the level of the electric field of each response data received is equal to or greater than the prescribed regulated value, but the response data signals transmitted are superposed on each other, so it becomes impossible to judge whether or not the contents of these received response data are correct. However, based on the reception electric field level equal to or greater than the prescribed regulated value, it is recognized that the second ground device 11b is receiving radio waves from a plurality of underground devices 3a, 3b, as a consequence of which the indication (e.g., buzzer sound, etc.) generated by the buzzer can be changed so as to discriminate the response data received from the plurality of underground devices 3a, 3b from each other. Thus, it is possible to detect the underground devices 3a, 3b while receiving the response data transmitted therefrom. In addition, the respective ID numbers of the underground devices 3a, 3b are indicated or displayed by the ID. indicating section of the ground device 11b, whereby the plurality of underground devices 3a, 3b detected can be specified or discriminated respectively.

Next, in the case where there are no underground devices 3a, 3b present near the third ground device 11c, that is, when the third ground device 11c exists outside the electric field areas 4a, 4b, the level of the electric field of response data received by the third ground device 11c is outside or less than the prescribed regulated value and hence the third ground device 11c can not recognize any response data from the the underground devices 3a, 3b. At this time, the buzzer of the ground device 11c generates, as an indication, a buzzer sound in the form of an “intermittent sound at short intervals”, thus notifying the operator or detecting person of the fact that there are no underground devices 3a, 3b existing in the vicinity of the ground device 11c.

Here, it should be noted that the embodiment described above is merey one example for explaining the present invention, and the present invention is not limited to the above embodiment but various changes or modifications thereof can be made within the spirit and scope of the appended claims. For instance, the above-mentioned embodiment has been described with reference to the case where a ground device receives the response data of two underground devices, but the present invention is not limited to such a case. Thus, the present invention can be applied to the case where the electric field areas of three or more underground devices overlap with one another, and in this case, too, it is possible to detect the presence of the plurality of underground devices substantially in the same manner as referred to above. Moreover, although in the above-mentioned embodiment, the MF band of radio waves has been used as a carrier, any frequency other than the MF band can be utilized for the same purpose as long as there is no fear that such a carrier may cause radio countermeasures or interference and a violation of the Wireless Radio Act or or other related government regulations. In addition, although in the above-mentioned embodiment, two underground devices have been detected and discriminated from each other, the present invention is not limited to this, but can be applied to such a case where three or more underground devices are detected and specified, if unique ID numbers are allocated in advance to the underground devices, respectively.

As described in the foregoing, according to the object detection system of the present invention, regulated data communications can be carried out between a detection device such as a ground device and objects such as underground devices buried in the underground with no mark attached thereto, so that the buried objects can be detected and specified in a considerably short period of time. Moreover, by switching or changing the magnitude of the radio wave transmission output radiated from a radio transmitter of the ground device or by adjusting the strength of the radio waves thus radiated, it is possible to narrow the place or area in which the buried objects lie in the underground, and search out individual buried objects, respectively.

What is claimed is:

1. An object detection system including a detection device for detecting objects present in unspecified places based on radio signals, said object detection system comprising:
a first transmitting and receiving section provided on said detection device for transmitting and receiving a radio signal; and
a second transmitting and receiving section provided on each of said objects to be detected for transmitting and receiving a radio signal;
wherein when said first transmitting and receiving section of said detection device transmits a radio signal for detecting said object, said second transmitting and receiving section of each of said objects receives said radio signal transmitted from said first transmitting and receiving section and sends a radio signal representative of response information to said detection device when an electric field level of said radio signal received by said second transmitting and receiving section is equal to or greater than a predetermined value; and
said detection device detects the presence of said objects by judging from an electric field level of each of said radio signals received and the content of said response information received.

2. The object detection system as claimed in claim 1, wherein said detection device further comprises a directivity adjusting section for adjusting the strength and directivity of a radio signal to be transmitted therefrom, and said detection device transmits a radio signal, of which the strength and directivity are adjusted by said directivity adjusting section, to said objects thereby to narrow the places of existence of said objects.

3. The object detection system as claimed in claim 2, wherein said detection device further comprises an indication section for indicating the detection of said objects, and when said detection device judges the presence of each object based on the magnitude of the electric field level of each radio signal received, said indication section changes a state of indication according to the number of objects which have been detected by said detection device.

4. The object detection system as claimed in claim 1, wherein said objects are each provided with an ID number for identification thereof, and said detection device further comprises an ID indicating section for identifying said objects respectively, and said ID indicating section indicates the ID numbers of said objects detected by said detection device, thereby individually identifying the plurality of objects detected by said detection device.

5. The object detection system as claimed in claim 1, wherein radio signals communicated between said detection device and said objects have frequencies of a MF band provided by the Wireless Radio Act Enforcement Rule.
